(19) United States
(12) Patent Application Publication
(10) Pub. No.: US 2026/0264184 A1
(43) Pub. Date: Sep. 10, 2026

(54) A Process Method For Automatic Feeding And Discharging Of Multi-Procedure Product On CNC Machining Device

(71) Applicant: SHENZHEN FSJ INTELLIGENT TECHNICAL CO., LTD., Shenzhen, Guangdong (CN)

(72) Inventor: Xuehong Liu, Shenzhen, Guangdong (CN)

(21) Appl. No.: 19/129,638

(22) PCT Filed: Sep. 28, 2023
(86) PCT No.: PCT/CN2023/122792

§ 371 Date: Jun. 1, 2026

(30) Foreign Application Priority Data
Nov. 23, 2022 (CN) 202211476431.6

(51) Int. Cl. B23Q 7/04; B23Q 39/04; B25J 9/16; G05B 19/418

(52) U.S. Cl. CPC B23Q 7/041; B23Q 7/043; B23Q 7/046; B23Q 39/046; G05B 19/4189; B25J 9/1625; G05B 2219/50386

(57) ABSTRACT

The present invention discloses a process method for automatic feeding and discharging of multi-procedure product on CNC machining device, belonging to the technical field of CNC machining device, and the present invention aims to provide a process method for automatic feeding and discharging of multi-procedure product on CNC machining device, and when the method is used for processing multi-procedure materials, this method flips the process surface and rotate the locating surface of unprocessed materials according to the process requirements, solving the problem of manual flipping during the automatic feeding and discharging process of multi-procedure products for CNC machining device, and the problem of merely a few matching products due to the small clamping range of clamping jaw during the feeding and discharging process. so that the method can, without manual object flipping, reduce production costs, improve the production efficiency of CNC machining device, and make significant improvement in terms of production capacity, yield rate and personnel working environment.

### TECHNICAL FIELD

The present invention relates to the field of CNC machining device technology, and more specifically, to a process method for automatic feeding and discharging of multi-procedure product on CNC machining device.

### BACKGROUND

The traditional material feeding and discharging machine for CNC machining device requires the CNC machining machine tool, material platform, clamping jaw mechanism, and locating and clamping mechanism, and the process flow is as follows: the material is manually placed on the material platform, then grasped by the clamping jaw mechanism and moved to the locating and clamping mechanism, and the material processed by the CNC machining machine is then collected by the clamping jaw mechanism to the material platform, which is a process flow for single process product processing; For multi-procedure products, after the material is grasped by the clamping jaw mechanism to the material platform, the process surface of material has to be manually flipped and the locating surface of the material has to be manually rotated. The traditional automatic material feeding and discharging process flow for CNC machining device can only meet the automatic material feeding and discharging for single process products, and for multi-procedure products, manual assistance is required to flip the process surface and rotate the locating surface. The traditional feeding and discharging machine has two sets of clamping jaw mechanisms, which cannot meet the needs of grasping multi-procedure products.

To address the shortcomings of traditional automatic material feeding and discharging processes for CNC machining device, a process method for automatic feeding and discharging of multi-procedure product on CNC machining device is proposed.

### SUMMARY

### 1. Technical Problems to be Addressed

In response to the existing problems in the prior art, the present invention aims to provide a process method for automatic feeding and discharging of multi-procedure product on CNC machining device, solving the problem of manual flipping during the automatic feeding and discharging process of multi-procedure products for CNC machining device, and the problem of merely a few matching products due to the small clamping range of clamping jaw during the feeding and discharging process.

### 2. Technical Solution

To address the above problems, the present invention adopts the following technical solution.

A process method for automatic feeding and discharging of multi-procedure product on CNC machining device, comprising the following steps:
S1: a technological process in which truss manipulator feeds and discharges materials for the CNC machining device for the first time when processing unprocessed materials of a single process product;
S2: a technological process in which truss manipulator feeds and discharges materials for the CNC machining device for the second time (as well as all subsequent unprocessed materials for this process) when processing unprocessed materials of a single process product;
S3: a technological process in which truss manipulator feeds and discharges materials in the first process for the CNC machining device for the first time when processing unprocessed materials of a multi-procedure product;
S4: a technological process in which truss manipulator feeds and discharges materials in the first process for the CNC machining device for the second time (and all subsequent unprocessed materials for this process) when processing a multi-procedure product;
S5: a technological process in which truss manipulator feeds and discharges materials in the second process for the CNC machining device for the first time (and all subsequent unprocessed materials for this process) when processing a multi-procedure product;
S6: a technological process in which truss manipulator feeds and discharges materials in the second process for the CNC machining device for the second time (and all subsequent unprocessed materials for this process) when processing a multi-procedure product;

In further, the CNC machining equipment in S comprises a material transfer platform, feeding and discharging machine assembly, and a material platform locating and clamping assembly 5; the top of the material transfer platform is provided with a locating surface rotating assembly, a pair of automatic process surface flipping assemblies, and a rotating assembly material tray, the feeding and discharging machine assembly include a truss manipulator and a right-angled clamping jaw assembly, the right-angled clamping jaw assembly is installed with clamping jaw 1, clamping jaw 2, clamping jaw 3, and clamping jaw 4, and the top of the material platform is installed with a material platform tray.

In further, the technological process in S1 in which truss manipulator feeds and discharges materials for the CNC machining device for the first time includes:
Step S11: Manually place unprocessed materials on the material platform;
Step S12: The truss manipulator grasps unprocessed materials from the material platform through 1 # clamping jaw on the clamping jaw mechanism, the clamping jaw mechanism driven by the truss manipulator moves to a suitable position outside the CNC machining device, rotates and moves 2 # clamping jaw to grasping working position, waiting for the CNC machining device to process the material from the previous process, and there is no processed material for the first time;
Step S13: After the material from the previous process is processed, the clamping jaw mechanism driven by the truss manipulator moves to an appropriate position of the locating and clamping mechanism on the CNC machining device, 2 # clamping jaw grasps the processed material on the locating and clamping mechanism, and the clamping jaw mechanism rotates or moves 1 # clamping jaw to the appropriate working position to place unprocessed material a in the locating and clamping mechanism, and under the drive of the truss manipulator, the clamping jaw mechanism clamping processed material moves outside the CNC machining device;
Step S14: The clamping jaw mechanism driven by the truss manipulator clamps and moves the processed material to the material platform, and rotates or moves 2 # clamping jaw to the working position to place the processed material back to the corresponding numbered position on the material platform.

In further, the technological process in S2 in which truss manipulator feeds and discharges materials for the CNC machining device for the second time includes:
Step S21: The truss manipulator grasps unprocessed material b from the material platform through 1 # clamping jaw on the clamping jaw mechanism, and sequentially grabs materials with different numbers a., b., c . . . , the clamping jaw mechanism driven by the truss manipulator moves to a suitable position outside the CNC machining device, and rotates and moves 2 # clamping jaw to the working position, waiting for the CNC machining device to process the material from the previous process;
Step S22: After the material from the previous process is processed, the clamping jaw mechanism driven by the truss manipulator moves to the appropriate position of the locating and clamping mechanism on the CNC machining device, 2 # clamping jaw grasps processed material a1 on the locating and clamping mechanism, and sequentially grasps different numbered materials a1. b1. c1 . . . , the clamping jaw mechanism rotates or moves 1 # clamping jaw to the appropriate working position to place the unprocessed material b into the locating and clamping mechanism, and under the drive of the truss manipulator, the clamping jaw mechanism clamping processed material a1 moves outside the CNC machining device;
Step S23: The clamping jaw mechanism driven by the truss manipulator grasps processed material a1 and moves to the material platform, and then rotates or moves 2 # clamping jaw to the working position, and places processed material a1 back to the corresponding numbered position on the material platform;
Step S24: After the truss manipulator performs operation for the CNC machining device for the third time, the technological process of feeding and discharging all materials is the same as that for the second material feeding and discharging, continuously repeat steps S21, S22, and S23 to automatically feed and discharge all materials on the material platform.

In further, the technological process in S3 in which truss manipulator feeds and discharges materials in the first process for the CNC machining device for the first time when processing unprocessed materials of a multi-procedure product includes:
Step S31: Manually place unprocessed materials on the material platform;
Step S32: The truss manipulator grasps unprocessed material a from the material platform through 1 # clamping jaw on the clamping jaw mechanism, and sequentially grasps materials with different numbers a., b., c . . . , the clamping jaw mechanism driven by the truss manipulator moves to a suitable position outside the CNC machining device, and rotates or moves 2 # clamping jaw to the working position, waiting for the CNC machining device to process the material from the previous process, and there is no processed material for the first time;
Step S33: After the material from the previous process is processed, the clamping jaw mechanism driven by the truss manipulator moves to the appropriate position of the locating and clamping mechanism on the CNC machining device, 2 # clamping jaw grasps the processed material on the locating and clamping mechanism, and the clamping jaw mechanism rotates or moves 1 # clamping jaw to the appropriate working position, places unprocessed material a in the locating and clamping mechanism, and under the drive of the truss manipulator, the clamping jaw mechanism clamping processed material moves outside the CNC machining device;
Step S34: Driven by the truss manipulator, the clamping jaw mechanism clamping processed material moves to the upper part of material transfer platform, rotates or moves 2 # clamping jaw to the working position, and places processed material on the material tray of locating and rotating mechanism of the material transfer platform and according to the material processing technology and material size, the clamping jaw mechanism rotates or moves 3 # clamping jaw to the working position, and other clamping jaws may be selected according to actual needs;
Step S35: According to the needs of flipping process surface and rotating locating surface of the material, the automatic process surface flipping mechanism grasps processed material from the material tray of locating and rotating mechanism of the transfer platform, and after flipping to the process surface in the second process, places processed material back on the material tray of the locating and rotating mechanism, and the locating and rotating mechanism automatically rotates to meet the needs of flipping process surface and rotating locating surface of materials;
Step S36: Driven by the truss manipulator, 3 # clamping jaw of the clamping jaw mechanism grasps, from the material tray of locating and rotating mechanism, the processed materials for which the process surface has been flipped and the locating surface has been rotated, moves and places processed materials back to the corresponding numbered position on the material platform, and other clamping jaws may be selected according to actual needs.

In further, the process flow in S4 in which truss manipulator feeds and discharges materials in the first process for the CNC machining device for the second time includes:
Step S41: The clamping jaw mechanism rotates or moves 1 # clamping jaw to the working position, the 1 # clamping jaw on the clamping jaw mechanism grasps unprocessed material b, and sequentially grasps materials with different numbers a., b., c., the clamping jaw mechanism driven by the truss manipulator moves to a suitable position outside the CNC machining device, and rotates or moves 2 # clamping jaw to the working position, waiting for the CNC machining device to process the material from the previous process, and other clamping jaws may be selected according to actual needs;
Step S42: After the material from the previous process is processed, the clamping jaw mechanism driven by the truss manipulator moves to an appropriate position of the locating and clamping mechanism on the CNC machining device, 2 # clamping jaw grasps processed material a1 and sequentially grasps different numbered materials a1. b1. c1 . . . , the clamping jaw mechanism rotates or moves 1 # clamping jaw to the working position, and places material b on the locating and clamping mechanism, and under the drive of the truss manipulator, the clamping jaw mechanism clamping processed material a1 moves outside the CNC machining device;
Step S43: Driven by the truss manipulator, the clamping jaw mechanism clamping processed material a1 moves to the material transfer platform, the clamping jaw mechanism rotates or moves 2 # clamping jaw to the working position, places processed material a1 on the material tray of locating and rotating mechanism of the material transfer platform, and according to the material processing technology and material size, the clamping jaw mechanism rotates or moves 3 # clamping jaw to the working position, and other clamping jaws may be selected according to actual needs;
Step S44: According to the needs of flipping process surface and rotating locating surface of the material, the automatic process surface flipping mechanism grasps processed material a1 from the material tray of locating and rotating mechanism of the transfer platform, and after flipping to the process surface in the second process, places processed material a1 back on the material tray of the locating and rotating mechanism, and the locating and rotating mechanism automatically rotates to meet the needs of flipping process surface and rotating locating surface of materials;
Step S45: Driven by the truss manipulator, 3 # clamping jaw of the clamping jaw mechanism grasps, from the material tray of locating and rotating mechanism, the processed material a1 for which the process surface has been flipped and the locating surface has been rotated, moves and places processed materials back to the corresponding numbered position on the material platform.
Step S46: After the truss manipulator completes the first process of the CNC machining device for the third time, the technological process of feeding and discharging all materials is the same as that for the second material feeding and discharging in the first process, continuously repeat the steps S41, S42, S43, S44, and S45 in cycle to automatically complete the feeding and discharging, the flipping of process surface, and the rotation of locating surface of all materials on the material platform in the first process until the first process is completed for all materials on the material platform.

In further, the technological process in S5 in which truss manipulator feeds and discharges materials in the second process for the CNC machining device for the first time includes:
Step S51: The truss manipulator grasps the material a1 for secondary processing from the material platform through 3 # clamping jaw on the clamping jaw mechanism, and sequentially grasps different numbered materials a1, b1, c1 . . . , the clamping jaw mechanism driven by the truss manipulator moves to a suitable position outside the CNC machining device, and rotates or moves 4 # clamping jaw to the working position, waiting for the CNC machining device to process the material from the previous process, and other clamping jaws may be selected according to actual needs;
Step S52: After the material from the previous process is processed, the clamping jaw mechanism driven by the truss manipulator moves to an appropriate position of the locating and clamping mechanism on the CNC machining device, 4 # clamping jaw grasps the secondary-processed material from the locating and clamping mechanism, the clamping jaw mechanism rotates or moves 3 # clamping jaw to the appropriate working position, places the material a1 to be secondary-processed in the locating and clamping mechanism, and under the drive of the truss manipulator, the clamping jaw mechanism clamping the secondary-processed material moves outside the CNC machining device;
Step S53: Driven by the truss manipulator, the clamping jaw mechanism clamping secondary-processed material moves to the material transfer platform, the clamping jaw mechanism rotates or moves 4 # clamping jaw to the working position, places secondary-processed material on the material tray of locating rotating mechanism of the material transfer platform, and according to the material processing technology and material size, the clamping jaw mechanism rotates or moves 2 # clamping jaw to the working position, and other clamping jaws may be selected according to actual needs;
Step S54: According to the needs of flipping process surface and rotating locating surface of the material, the automatic process surface flipping mechanism grasps secondary-processed material from the material tray of locating and rotating mechanism of the transfer platform, and after flipping to the process surface in the third process, places secondary-processed material back on the material tray of locating and rotating mechanism, and the locating and rotating mechanism automatically rotates to meet the needs of flipping process surface and rotating locating surface of secondary-processed materials;
Step S55: Driven by the truss manipulator, 2 # clamping jaw of the clamping jaw mechanism grasps, from the material tray of locating and rotating mechanism, the secondary-processed materials for which the process surface has been flipped and the locating surface has been rotated, moves and places secondary-processed materials back to the corresponding numbered position on the material platform.

In further, The technological process in S6 in which truss manipulator feeds and discharges materials in the second process for the CNC machining device for the second time includes:
Step S61: The clamping jaw mechanism rotates or moves 3 # clamping jaw to the working position, the 1 # clamping jaw on the clamping jaw mechanism grasps the material b1 to be secondary-processed, and sequentially grasps different numbered materials a1, b1, c1 . . . , and under the drive of the truss manipulator, the clamping jaw mechanism moves to a suitable position outside the CNC machining device, rotates or moves 4 # clamping jaw to the working position, waiting for the CNC machining device to process the material from the previous process;
Step S62: After the material from the previous process is processed, the clamping jaw mechanism driven by the truss manipulator moves to an appropriate position of the locating and clamping mechanism on the CNC machining device, 4 # clamping jaw mechanism and locating and clamping mechanism grasps the secondary-processed material a2, and sequentially grasps different numbered materials a2..b2.c2 . . . , the clamping jaw mechanism rotates or moves 3 # clamping jaw to the working position, places the material b1 to be secondary-processed into the locating and clamping mechanism, and under the drive of the truss manipulator, the clamping jaw mechanism clamping the secondary-processed material a2 moves outside the CNC machining device;
Step S63: Driven by the truss manipulator, the clamping jaw mechanism clamping the secondary-processed material a2 moves to the material transfer platform, rotates or moves 4 # clamping jaw to the working position, and places the secondary-processed material a2 on the material tray of locating rotating mechanism of the material transfer platform and, according to the material processing technology and material size, the clamping jaw mechanism rotates or moves 2 # clamping jaw to the working position, and other clamping jaws may be selected according to actual needs;
Step S64: According to the needs of flipping process surface and rotating locating surface of the material, the automatic process surface flipping mechanism grasps secondary-processed material a2 from the material tray of locating and rotating mechanism of the transfer platform, and after flipping to the process surface in the third process, places secondary-processed material a2 back on the material tray of the locating and rotating mechanism, and the locating and rotating mechanism automatically rotates to meet the needs of flipping process surface and rotating locating surface of materials;
Step S65: Driven by the truss manipulator, 2 # clamping jaw of the clamping jaw mechanism grasps, from the material tray of locating and rotating mechanism, the secondary-processed materials a2 for which the process surface has been flipped and the locating surface has been rotated, moves and places secondary-processed materials a2 back to the corresponding numbered position on the material platform, and other clamping jaws may be selected according to actual needs.
Step S66: After the truss manipulator completes the second process of the CNC machining device for the third time, the technological process of feeding and discharging all materials is the same as that for the second material feeding and discharging in the second process, continuously repeat the steps S61, S62, S63, S64, and S65 in cycle to automatically complete the feeding and discharging, the flipping of process surface, and the rotation of locating surface of all materials on the material platform in the second process until the second process is completed for all materials on the material platform.

In further, in step S6, the technological process of truss manipulator feeding and discharging, flipping the process surface, and rotating the locating surface of all materials on the material platform in the third process is the same as that for the second process, continuously repeat the steps S51, S52, S53, S54, S55, S61, S62, S63, S64, S65 and S66 in cycle to automatically complete the feeding and discharging, the flipping of process surface, and the rotation of locating surface of all materials on the material platform in all processes until all the processes are completed for all materials on the material platform.

In further, in S1-S6, the technological process of CNC machining device has 6 ways to flip process surface, 4 ways to rotate locating surface, and 12 ways to grasp material, and 188 commonly used process methods can be combined based on the effective permutation and combination of the method to flip the process surface, rotate locating surface, and grasping by the clamping jaw.

### 3. Beneficial Effects

Compared to prior art, the present invention has the following advantages:
(1) The solution can, without manual object flipping, reduce production costs, improve the production efficiency of CNC machining device, and make significant improvement in terms of production capacity, yield rate and personnel working environment.
(2) By manufacturing multi-procedure finished products on a single machine, this solution can greatly solve the problem of uneven machine ratio, shorten the idle time of machines with less machines, and fully improve the machine's production capacity based on the around-the-clock operation at lower cost.
(3) By automatically completing the feeding and discharging of multi-procedure products for CNC machining equipment, this solution reduces labor force and improve the processing efficiency and yield of processed products, and effectively addresses the dilemma of personnel management in the processing industry, while reducing the occurrence probability of uncontrollable costs in the industry.

### BRIEF DESCRIPTION OF THE DRAWINGS

FIG. 1 is a schematic diagram of the three-dimensional structure of the material transfer platform assembly in the present invention;

FIG. 2 is a schematic diagram of the three-dimensional structure of the feeding and discharging machine assembly in the present invention;

FIG. 3 is a schematic diagram of the three-dimensional structure of the right-angled clamping jaw assembly in the present invention;

FIG. 4 is a schematic diagram of the three-dimensional structure of the material platform in the present invention;

FIG. 5 is a schematic diagram of the three-dimensional structure of the locating and clamping assembly in the present invention;

FIG. 6 is a schematic diagram of the three-dimensional structure of the flat right-angled clamping jaw assembly in the present invention;

FIG. 7 is a schematic diagram of the process flow in the present invention;

FIG. 8 is a schematic diagram of the method of flipping process surface, rotating locating surface, and grasping by the clamping jaw in the present invention;

FIG. 9 is a schematic diagram of the method of flipping process surface, rotating locating surface, and grasping by the clamping jaw in the present invention;

FIG. 10 is a schematic diagram of the method of flipping process surface, rotating locating surface, and grasping by the clamping jaw in the present invention;

FIG. 11 is a schematic diagram of the method of flipping process surface, rotating locating surface, and grasping by the clamping jaw in the present invention;

FIG. 12 is a schematic diagram of the method of flipping process surface, rotating locating surface, and grasping by the clamping jaw in the present invention;

FIG. 13 is a schematic diagram of the method of flipping process surface, rotating locating surface, and grasping by the clamping jaw in the present invention;

FIG. 14 is a schematic diagram of the method of flipping process surface, rotating locating surface, and grasping by the clamping jaw in the present invention;

FIG. 15 is a schematic diagram of the method of flipping process surface, rotating locating surface, and grasping by the clamping jaw in the present invention;

FIG. 16 is a schematic diagram of the method of flipping process surface, rotating locating surface, and grasping by the clamping jaw in the present invention.

Where:
1. Material transfer platform; 2. Feeding and discharging machine assembly; 3. Material platform; 4. right-angled clamping jaw assembly; 5. Locating and clamping assembly; 6. Truss manipulator; 7. Flat clamping jaw assembly; 21. Locating surface rotating assembly; 22. Automatic process surface flipping assembly; 23. Material tray of rotating assembly; 31. Material platform tray; 41. 1 # clamping jaw; 42. 2 # clamping jaw; 43. 3 # clamping jaw; 44. 4 # clamping jaw; 5. Locating and clamping assembly.

### DETAILED DESCRIPTION OF EMBODIMENTS

The technical solutions in the embodiments of the present invention will be described clearly and completely in conjunction with the accompanying drawings of the embodiments of the present invention. Obviously, the described embodiments are only a part of the embodiments of the present invention, rather than all the embodiments. Based on the embodiments of the present invention, all other embodiments obtained by those of ordinary skill in the art without creative work shall fall within the protection scope of the present invention.

In the description of the present invention, it should be noted that the terms “up”, “down”, “inside”, “outside”, “top/bottom”, etc. indicate orientation or position relationships based on the orientation or position relationships shown in the accompanying drawings, only for the convenience of describing the present invention and simplifying the description, and do not indicate or imply that the device or element referred to must have a specific orientation, be constructed and operated in a specific orientation, and therefore cannot be understood as limiting the present invention. In addition, the terms “first” and “second” are only used for descriptive purposes and cannot be understood as indicating or implying relative importance.

In the description of the present invention, it should be noted that unless otherwise specified and limited, the terms “installation”, “provided with”, “sleeved/connected with”, “connection”, etc. should be broadly understood and, for example, “connection” can be a fixed connection, a detachable connection, or an integral connection; and can be a mechanical connection or an electrical connection; can be direct connection, indirect connection through an intermediate medium, or internal connection between two assemblies. The person having ordinary skill in the art can understand the specific meanings of the above terms in the present invention in specific situations.

### Example 1

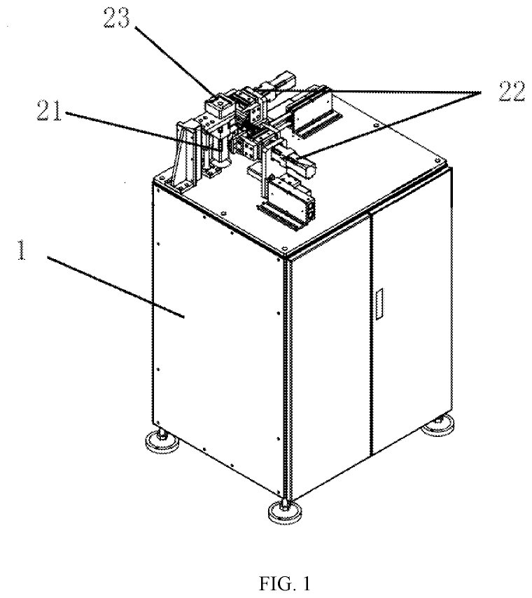

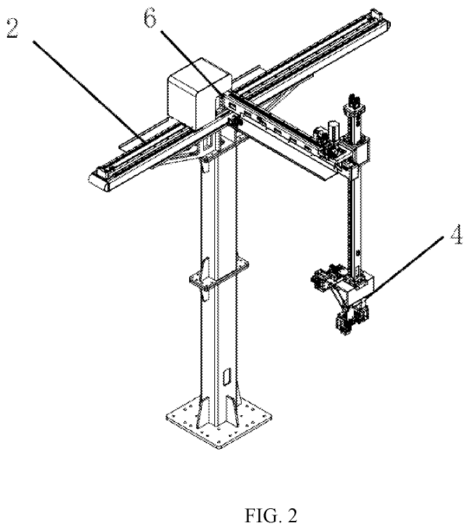

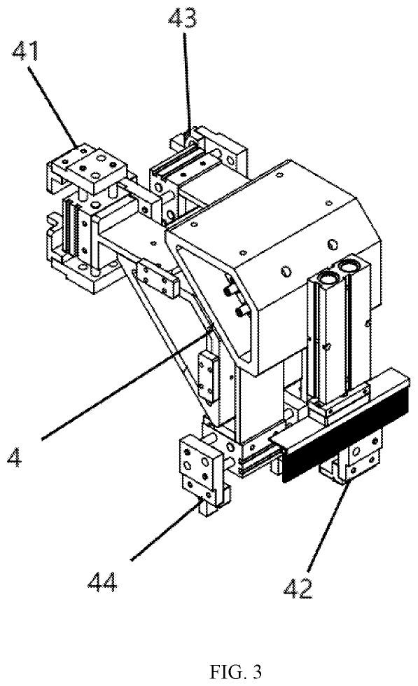

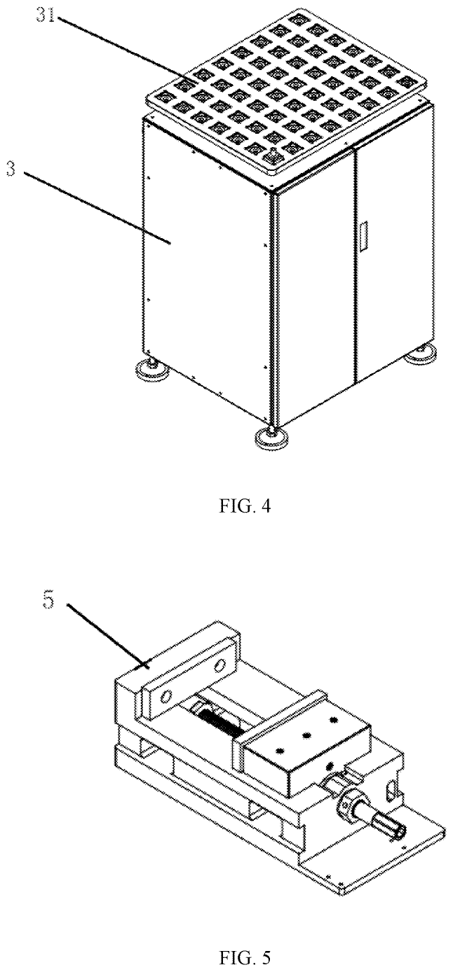

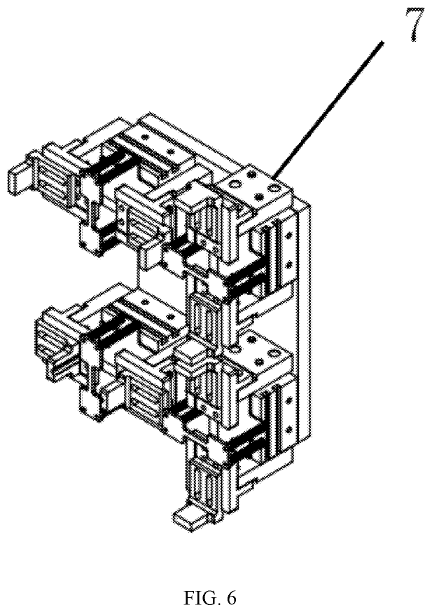

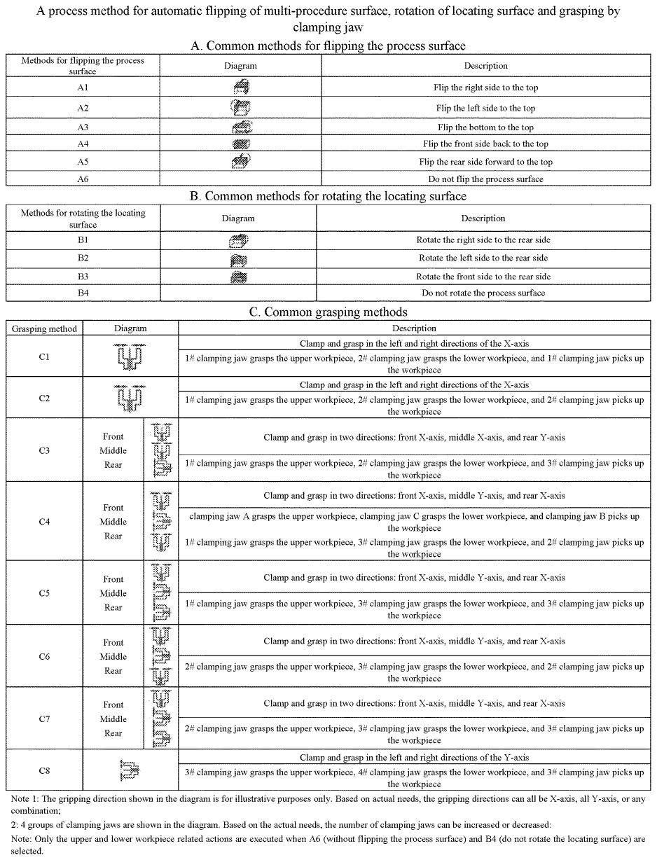

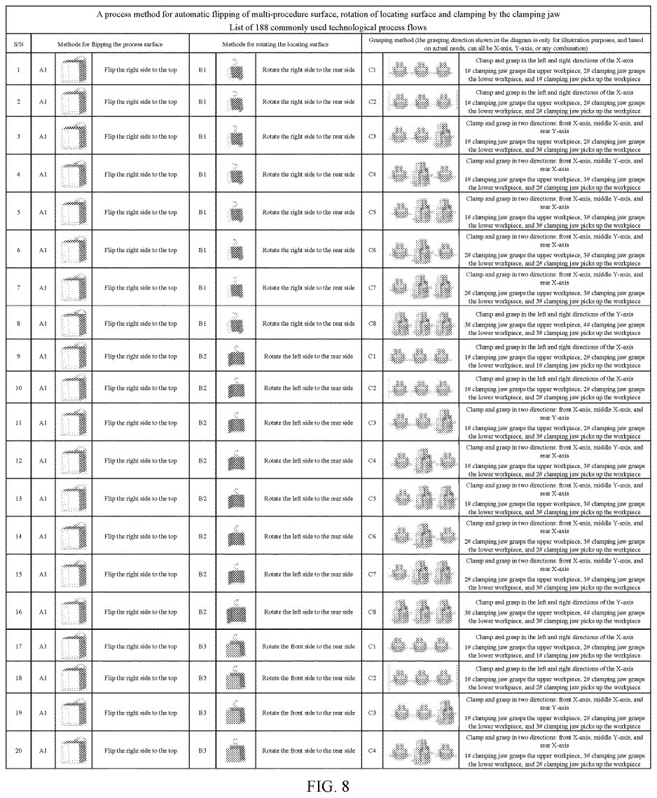

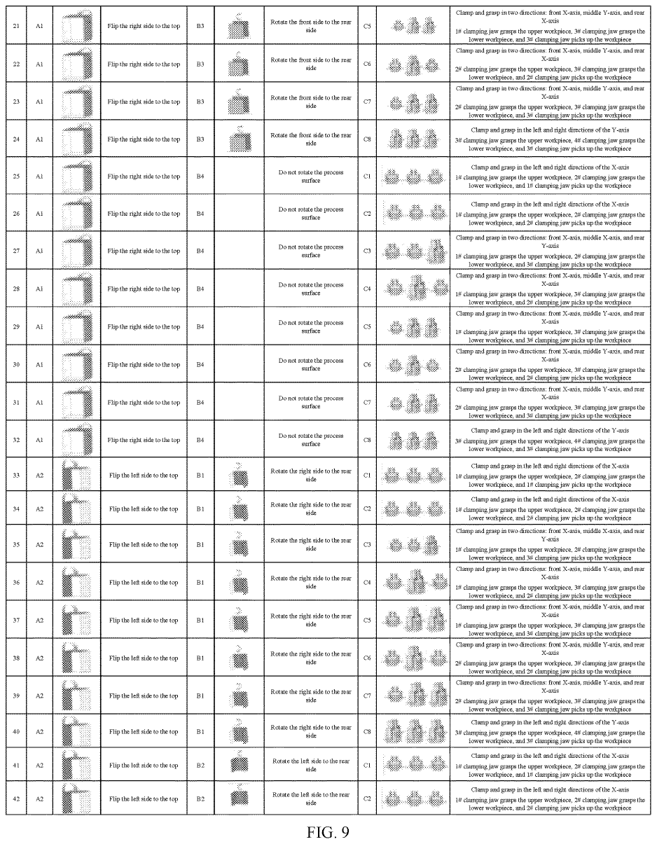

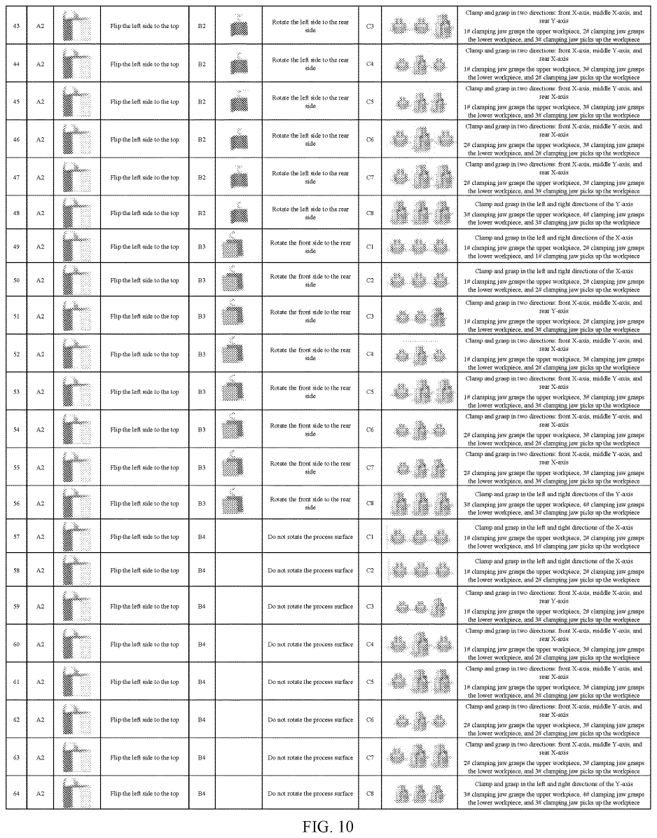

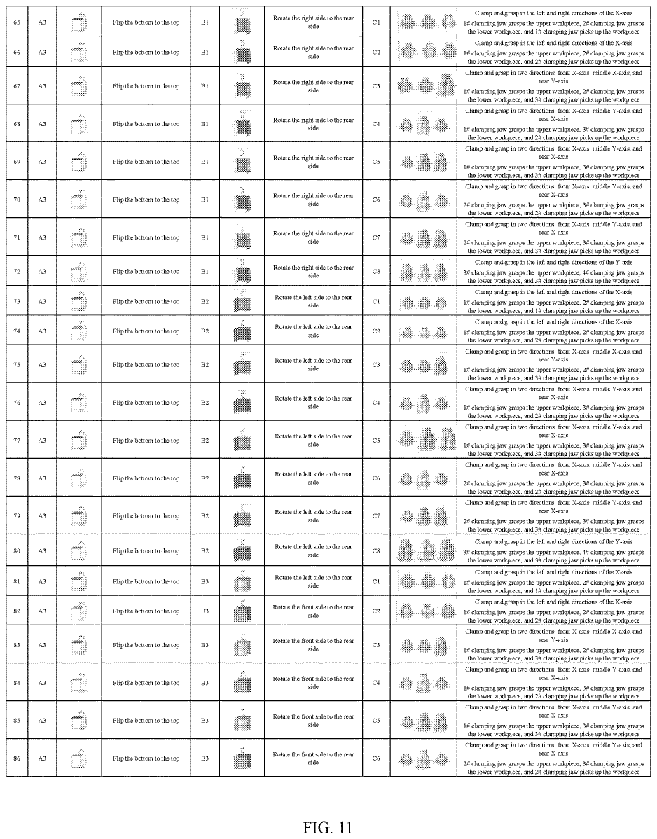

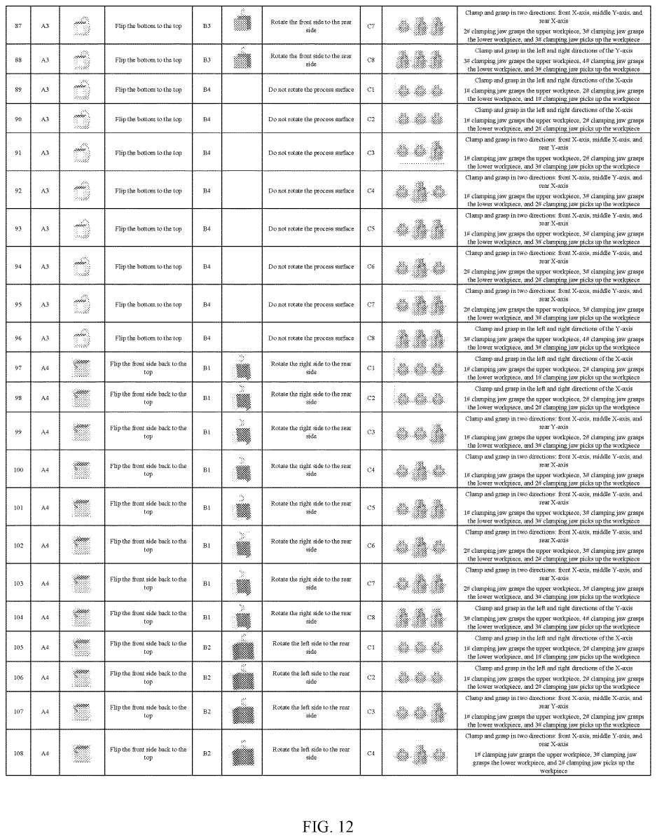

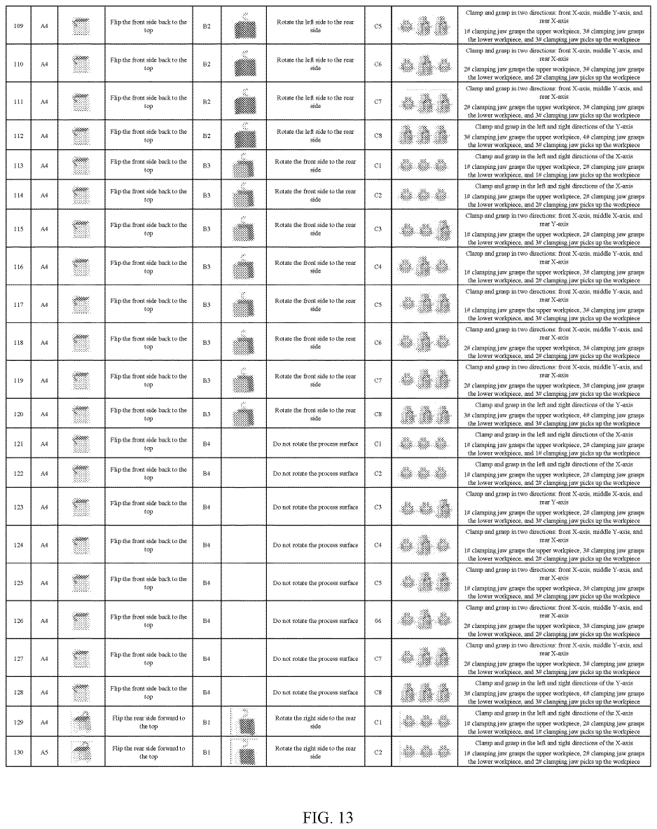

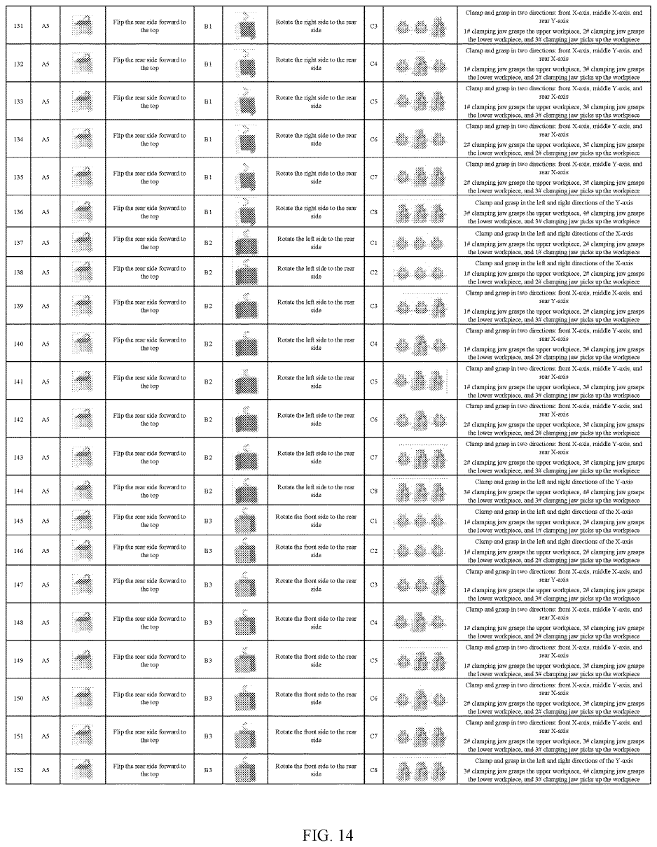

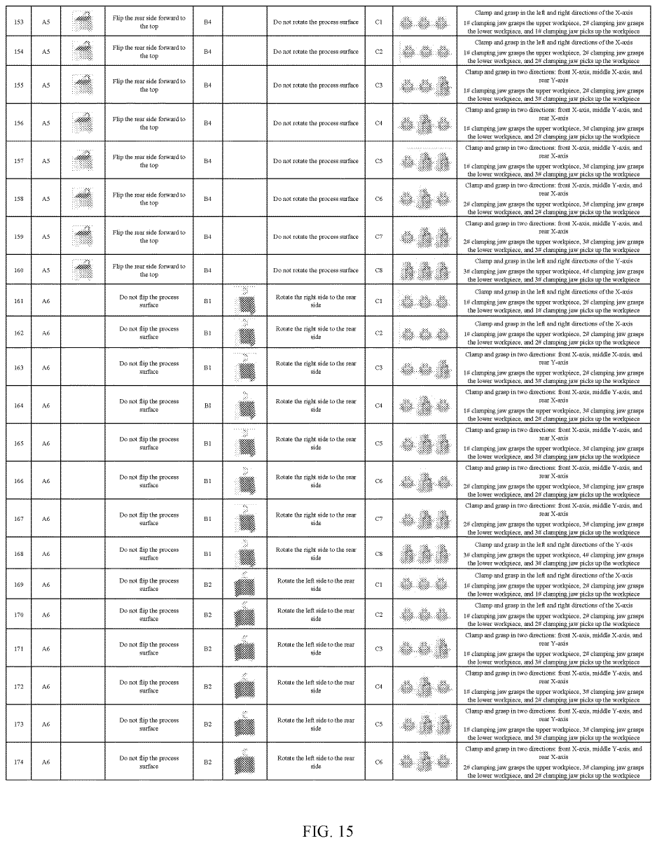

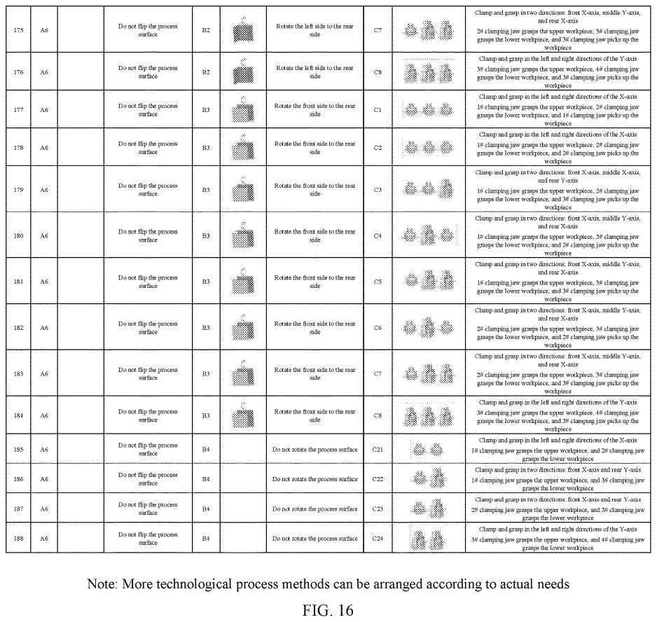

As shown in FIG. 1-16, a process method for automatic feeding and discharging of multi-procedure product on CNC machining device, comprising the following steps:
S1: a technological process in which truss manipulator feeds and discharges materials for the CNC machining device for the first time when processing unprocessed materials of a single process product;
S2: a technological process in which truss manipulator feeds and discharges materials for the CNC machining device for the second time (as well as all subsequent unprocessed materials for this process) when processing unprocessed materials of a single process product;
S3: a technological process in which truss manipulator feeds and discharges materials in the first process for the CNC machining device for the first time when processing unprocessed materials of a multi-procedure product;
S4: a technological process in which truss manipulator feeds and discharges materials in the first process for the CNC machining device for the second time (and all subsequent unprocessed materials for this process) when processing a multi-procedure product;
S5: a technological process in which truss manipulator feeds and discharges materials in the second process for the CNC machining device for the first time (and all subsequent unprocessed materials for this process) when processing a multi-procedure product;
S6: a technological process in which truss manipulator feeds and discharges materials in the second process for the CNC machining device for the second time (and all subsequent unprocessed materials for this process) when processing a multi-procedure product;

The CNC machining device in S2 comprises a material transfer platform 1, a feeding and discharging machine assembly 2, a material platform 3, and a locating and clamping assembly 5, the top of the material transfer platform 1 is provided with a locating surface rotating assembly 21, a pair of automatic process surface flipping assemblies 22, and a rotating assembly material tray 23, and the feeding and discharging machine assembly 2 comprises a truss manipulator 6 and a right-angled clamping jaw assembly 4, the right-angled clamping jaw assembly 4 is installed with 1 # clamping jaw 41, 2 # clamping jaw 42, 3 # clamping jaw 43, and 4 # clamping jaw 44, and a material platform tray 31 is installed at the top of the material platform 3.

The technological process in S1 in which truss manipulator feeds and discharges materials for the CNC machining device for the first time includes:
Step S11: Manually place unprocessed materials on the material platform;
Step S12: The truss manipulator grasps unprocessed materials from the material platform through 1 # clamping jaw on the clamping jaw mechanism, the clamping jaw mechanism driven by the truss manipulator moves to a suitable position outside the CNC machining device, rotates and moves 2 # clamping jaw to grasping working position, waiting for the CNC machining device to process the material from the previous process, and there is no processed material for the first time;
Step S13: After the material from the previous process is processed, the clamping jaw mechanism driven by the truss manipulator moves to an appropriate position of the locating and clamping mechanism on the CNC machining device, 2 # clamping jaw grasps the processed material on the locating and clamping mechanism, and the clamping jaw mechanism rotates or moves 1 # clamping jaw to the appropriate working position to place unprocessed material a in the locating and clamping mechanism, and under the drive of the truss manipulator, the clamping jaw mechanism clamping processed material moves outside the CNC machining device;
Step S14: The clamping jaw mechanism driven by the truss manipulator clamps and moves the processed material to the material platform, and rotates or moves 2 # clamping jaw to the working position to place the processed material back to the corresponding numbered position on the material platform.

The technological process in S2 in which truss manipulator feeds and discharges materials for the CNC machining device for the second time includes:
Step S21: The truss manipulator grasps unprocessed material b from the material platform through 1 # clamping jaw on the clamping jaw mechanism, and sequentially grabs materials with different numbers a., b., c . . . , the clamping jaw mechanism driven by the truss manipulator moves to a suitable position outside the CNC machining device, and rotates and moves 2 # clamping jaw to the working position, waiting for the CNC machining device to process the material from the previous process;
Step S22: After the material from the previous process is processed, the clamping jaw mechanism driven by the truss manipulator moves to the appropriate position of the locating and clamping mechanism on the CNC machining device, 2 # clamping jaw grasps processed material a1 on the locating and clamping mechanism, and sequentially grasps different numbered materials a1. b1. c1 . . . , the clamping jaw mechanism rotates or moves 1 # clamping jaw to the appropriate working position to place the unprocessed material b into the locating and clamping mechanism, and under the drive of the truss manipulator, the clamping jaw mechanism clamping processed material a1 moves outside the CNC machining device;
Step S23: The clamping jaw mechanism driven by the truss manipulator grasps processed material a1 and moves to the material platform, and then rotates or moves 2 # clamping jaw to the working position, and places processed material a1 back to the corresponding numbered position on the material platform;
Step S24: After the truss manipulator performs operation for the CNC machining device for the third time, the technological process of feeding and discharging all materials is the same as that for the second material feeding and discharging, continuously repeat steps S21, S22, and S23 to automatically feed and discharge all materials on the material platform.

The technological process in S3 in which truss manipulator feeds and discharges materials in the first process for the CNC machining device for the first time when processing unprocessed materials of a multi-procedure product includes:
Step S31: Manually place unprocessed materials on the material platform;
Step S32: The truss manipulator grasps unprocessed material a from the material platform through 1 # clamping jaw on the clamping jaw mechanism, and sequentially grasps materials with different numbers a., b., c . . . , the clamping jaw mechanism driven by the truss manipulator moves to a suitable position outside the CNC machining device, and rotates or moves 2 # clamping jaw to the working position, waiting for the CNC machining device to process the material from the previous process, and there is no processed material for the first time;
Step S33: After the material from the previous process is processed, the clamping jaw mechanism driven by the truss manipulator moves to the appropriate position of the locating and clamping mechanism on the CNC machining device, 2 # clamping jaw grasps the processed material on the locating and clamping mechanism, and the clamping jaw mechanism rotates or moves 1 # clamping jaw to the appropriate working position, places unprocessed material a in the locating and clamping mechanism, and under the drive of the truss manipulator, the clamping jaw mechanism clamping processed material moves outside the CNC machining device;
Step S34: Driven by the truss manipulator, the clamping jaw mechanism clamping processed material moves to the upper part of material transfer platform, rotates or moves 2 # clamping jaw to the working position, and places processed material on the material tray of locating and rotating mechanism of the material transfer platform and according to the material processing technology and material size, the clamping jaw mechanism rotates or moves 3 # clamping jaw to the working position, and other clamping jaws may be selected according to actual needs;
Step S35: According to the needs of flipping process surface and rotating locating surface of the material, the automatic process surface flipping mechanism grasps processed material from the material tray of locating and rotating mechanism of the transfer platform, and after flipping to the process surface in the second process, places processed material back on the material tray of the locating and rotating mechanism, and the locating and rotating mechanism automatically rotates to meet the needs of flipping process surface and rotating locating surface of materials;
Step S36: Driven by the truss manipulator, 3 # clamping jaw of the clamping jaw mechanism grasps, from the material tray of locating and rotating mechanism, the processed materials for which the process surface has been flipped and the locating surface has been rotated, moves and places processed materials back to the corresponding numbered position on the material platform, and other clamping jaws may be selected according to actual needs.

The process flow in S4 in which truss manipulator feeds and discharges materials in the first process for the CNC machining device for the second time includes:
Step S41: The clamping jaw mechanism rotates or moves 1 # clamping jaw to the working position, the 1 # clamping jaw on the clamping jaw mechanism grasps unprocessed material b, and sequentially grasps materials with different numbers a., b., c., the clamping jaw mechanism driven by the truss manipulator moves to a suitable position outside the CNC machining device, and rotates or moves 2 # clamping jaw to the working position, waiting for the CNC machining device to process the material from the previous process, and other clamping jaws may be selected according to actual needs;
Step S42: After the material from the previous process is processed, the clamping jaw mechanism driven by the truss manipulator moves to an appropriate position of the locating and clamping mechanism on the CNC machining device, 2 # clamping jaw grasps processed material a1 and sequentially grasps different numbered materials a1. b1. c1 . . . , the clamping jaw mechanism rotates or moves 1 # clamping jaw to the working position, and places material b on the locating and clamping mechanism, and under the drive of the truss manipulator, the clamping jaw mechanism clamping processed material a1 moves outside the CNC machining device;
Step S43: Driven by the truss manipulator, the clamping jaw mechanism clamping processed material a1 moves to the material transfer platform, the clamping jaw mechanism rotates or moves 2 # clamping jaw to the working position, places processed material a1 on the material tray of locating and rotating mechanism of the material transfer platform, and according to the material processing technology and material size, the clamping jaw mechanism rotates or moves 3 # clamping jaw to the working position, and other clamping jaws may be selected according to actual needs;
Step S44: According to the needs of flipping process surface and rotating locating surface of the material, the automatic process surface flipping mechanism grasps processed material a1 from the material tray of locating and rotating mechanism of the transfer platform, and after flipping to the process surface in the second process, places processed material a1 back on the material tray of the locating and rotating mechanism, and the locating and rotating mechanism automatically rotates to meet the needs of flipping process surface and rotating locating surface of materials;
Step S45: Driven by the truss manipulator, 3 # clamping jaw of the clamping jaw mechanism grasps, from the material tray of locating and rotating mechanism, the processed material a1 for which the process surface has been flipped and the locating surface has been rotated, moves and places processed materials back to the corresponding numbered position on the material platform.
Step S46: After the truss manipulator completes the first process of the CNC machining device for the third time, the technological process of feeding and discharging all materials is the same as that for the second material feeding and discharging in the first process, continuously repeat the steps S41, S42, S43, S44, and S45 in cycle to automatically complete the feeding and discharging, the flipping of process surface, and the rotation of locating surface of all materials on the material platform in the first process until the first process is completed for all materials on the material platform.

The technological process in S5 in which truss manipulator feeds and discharges materials in the second process for the CNC machining device for the first time includes:
Step S51: The truss manipulator grasps the material a1 for secondary processing from the material platform through 3 # clamping jaw on the clamping jaw mechanism, and sequentially grasps different numbered materials a1, b1, c1 . . . , the clamping jaw mechanism driven by the truss manipulator moves to a suitable position outside the CNC machining device, and rotates or moves 4 # clamping jaw to the working position, waiting for the CNC machining device to process the material from the previous process, and other clamping jaws may be selected according to actual needs;
Step S52: After the material from the previous process is processed, the clamping jaw mechanism driven by the truss manipulator moves to an appropriate position of the locating and clamping mechanism on the CNC machining device, 4 # clamping jaw grasps the secondary-processed material from the locating and clamping mechanism, the clamping jaw mechanism rotates or moves 3 # clamping jaw to the appropriate working position, places the material a1 to be secondary-processed in the locating and clamping mechanism, and under the drive of the truss manipulator, the clamping jaw mechanism clamping the secondary-processed material moves outside the CNC machining device;
Step S53: Driven by the truss manipulator, the clamping jaw mechanism clamping secondary-processed material moves to the material transfer platform, the clamping jaw mechanism rotates or moves 4 # clamping jaw to the working position, places secondary-processed material on the material tray of locating rotating mechanism of the material transfer platform, and according to the material processing technology and material size, the clamping jaw mechanism rotates or moves 2 # clamping jaw to the working position, and other clamping jaws may be selected according to actual needs;
Step S54: According to the needs of flipping process surface and rotating locating surface of the material, the automatic process surface flipping mechanism grasps secondary-processed material from the material tray of locating and rotating mechanism of the transfer platform, and after flipping to the process surface in the third process, places secondary-processed material back on the material tray of locating and rotating mechanism, and the locating and rotating mechanism automatically rotates to meet the needs of flipping process surface and rotating locating surface of secondary-processed materials;
Step S55: Driven by the truss manipulator, 2 # clamping jaw of the clamping jaw mechanism grasps, from the material tray of locating and rotating mechanism, the secondary-processed materials for which the process surface has been flipped and the locating surface has been rotated, moves and places secondary-processed materials back to the corresponding numbered position on the material platform. The technological process in S6 in which truss manipulator feeds and discharges materials in the second process for the CNC machining device for the second time includes:
Step S61: The clamping jaw mechanism rotates or moves 3 # clamping jaw to the working position, the 1 # clamping jaw on the clamping jaw mechanism grasps the material b1 to be secondary-processed, and sequentially grasps different numbered materials a1, b1, c1 . . . , and under the drive of the truss manipulator, the clamping jaw mechanism moves to a suitable position outside the CNC machining device, rotates or moves 4 # clamping jaw to the working position, waiting for the CNC machining device to process the material from the previous process;
Step S62: After the material from the previous process is processed, the clamping jaw mechanism driven by the truss manipulator moves to an appropriate position of the locating and clamping mechanism on the CNC machining device, 4 # clamping jaw mechanism and locating and clamping mechanism grasps the secondary-processed material a2, and sequentially grasps different numbered materials a2.b2.c2 . . ., the clamping jaw mechanism rotates or moves 3 # clamping jaw to the working position, places the material b1 to be secondary-processed into the locating and clamping mechanism, and under the drive of the truss manipulator, the clamping jaw mechanism clamping the secondary-processed material a2 moves outside the CNC machining device;
Step S63: Driven by the truss manipulator, the clamping jaw mechanism clamping the secondary-processed material a2 moves to the material transfer platform, rotates or moves 4 # clamping jaw to the working position, and places the secondary-processed material a2 on the material tray of locating rotating mechanism of the material transfer platform and, according to the material processing technology and material size, the clamping jaw mechanism rotates or moves 2 # clamping jaw to the working position, and other clamping jaws may be selected according to actual needs;
Step S64: According to the needs of flipping process surface and rotating locating surface of the material, the automatic process surface flipping mechanism grasps secondary-processed material a2 from the material tray of locating and rotating mechanism of the transfer platform, and after flipping to the process surface in the third process, places secondary-processed material a2 back on the material tray of the locating and rotating mechanism, and the locating and rotating mechanism automatically rotates to meet the needs of flipping process surface and rotating locating surface of materials;
Step S65: Driven by the truss manipulator, 2 # clamping jaw of the clamping jaw mechanism grasps, from the material tray of locating and rotating mechanism, the secondary-processed materials a2 for which the process surface has been flipped and the locating surface has been rotated, moves and places secondary-processed materials a2 back to the corresponding numbered position on the material platform, and other clamping jaws may be selected according to actual needs.
Step S66: After the truss manipulator completes the second process of the CNC machining device for the third time, the technological process of feeding and discharging all materials is the same as that for the second material feeding and discharging in the second process, continuously repeat the steps S61, S62, S63, S64, and S65 in cycle to automatically complete the feeding and discharging, the flipping of process surface, and the rotation of locating surface of all materials on the material platform in the second process until the second process is completed for all materials on the material platform.

In step S6, the technological process of truss manipulator feeding and discharging, flipping the process surface, and rotating the locating surface of all materials on the material platform in the third process is the same as that for the second process, continuously repeat the steps S51, S52, S53, S54, S55, S61, S62, S63, S64, S65 and S66 in cycle to automatically complete the feeding and discharging, the flipping of process surface, and the rotation of locating surface of all materials on the material platform in all processes until all the processes are completed for all materials on the material platform.

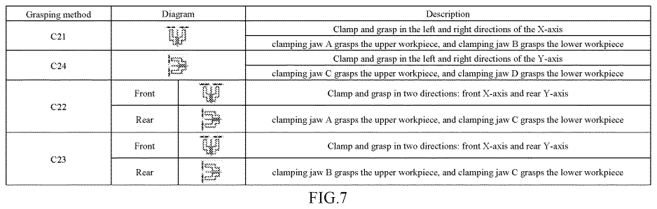

In S1-S6, the technological process of CNC machining device has 6 ways to flip process surface, 4 ways to rotate locating surface, and 12 ways to grasp material, and 188 commonly used process methods can be combined based on the effective permutation and combination of the method to flip the process surface, rotate locating surface, and grasp by the clamping jaw. The above ways to flip process surface, rotate locating surface, and grasp are shown in FIG. 7-16. More arrangement methods are available according to actual needs.

This solution provides a process method for automatic feeding and discharging of multi-procedure products for CNC machining equipment, and the CNC machining equipment comprises a material transfer platform 1, a feeding and discharging machine assembly 2, and a material platform 3, the feeding and discharging machine assembly 2 includes a truss manipulator 6 and a right-angled clamping jaw assembly 4, and the right-angled clamping jaw assembly 4 installed on the truss manipulator 6 has multiple clamping jaws, including 1 # clamping jaw 41, 2 # clamping jaw 42, 3 # clamping jaw 43, and 4 # clamping jaw 44, a pair of automatic process surface flipping assemblies 22 and locating surface rotating assemblies 21 are installed on the material transfer platform 1, the clamping jaw mechanism can be divided into right-angled clamping jaw assembly 4 and flat clamping jaw assembly according to the needs of different equipment; the first one can be arranged in a right angle shape, including 1 # clamp jaw 41, 2 # clamp jaw 42, 3 # clamp jaw 43, and 4 # clamp jaw 44, or more; the second one can be based on a flat layout, including 1 # clamp jaw 41, 2 # clamp jaw 42, 3 # clamp jaw 43, and 4 # clamp jaw 44, or more.

According to a pair of automatic process surface flipping assemblies 22, locating rotation assemblies 21, and right-angled clamping jaw assemblies 4, there are 6 ways to flip the process surface based on the processing technology of the CNC machining equipment, including:
A1: Flip the right side to the top
A2: Flip the left side to the top
A3: Flip the bottom to the top
A4: Flip the front side back to the top
A5: Flip the rear side forward to the top
A6: Do not flip the process surface

There are 4 ways to rotate the locating surface, including:
B1: Rotate the right side to the rear side
B2: Rotate the left side to the rear side
B3: Rotate the front side to the rear side
B4: Do not rotate the process surface

There are 12 ways to grasp by clamping jaws, including:
C1: Clamp and grasp in the left and right directions of the X-axis
1 # clamping jaw grasps the upper workpiece, 2 # clamping jaw grasps the lower workpiece, and 1 # clamping jaw picks up the workpiece
C2: Clamp and grasp in the left and right directions of the X-axis
1 # clamping jaw grasps the upper workpiece, 2 # clamping jaw grasps the lower workpiece, and 2 # clamping jaw picks up the workpiece
C3: Clamp and grasp in two directions: front X-axis, middle X-axis, and rear Y-axis
1 # clamping jaw grasps the upper workpiece, 2 # clamping jaw grasps the lower workpiece, and 3 # clamping jaw picks up the workpiece
C4: Clamp and grasp in two directions: front X-axis, middle Y-axis, and rear X-axis
clamping jaw A grasps the upper workpiece, clamping jaw C grasps the lower workpiece, and clamping jaw B picks up the workpiece
1 # clamping jaw grasps the upper workpiece, 3 # clamping jaw grasps the lower workpiece, and 2 # clamping jaw picks up the workpiece
C5: Clamp and grasp in two directions: front X-axis, middle Y-axis, and rear X-axis
1 # clamping jaw grasps the upper workpiece, 3 # clamping jaw grasps the lower workpiece, and 3 # clamping jaw picks up the workpiece
C6: Clamp and grasp in two directions: front X-axis, middle Y-axis, and rear X-axis
2 # clamping jaw grasps the upper workpiece, 3 # clamping jaw grasps the lower workpiece, and 2 # clamping jaw picks up the workpiece
C7: Clamp and grasp in two directions: front X-axis, middle Y-axis, and rear X-axis
2 # clamping jaw grasps the upper workpiece, 3 # clamping jaw grasps the lower workpiece, and 3 # clamping jaw picks up the workpiece
C8: Clamp and grasp in the left and right directions of the Y-axis
3 # clamping jaw grasps the upper workpiece, 4 # clamping jaw grasps the lower workpiece, and 3 # clamping jaw picks up the workpiece
C21: Clamp and grasp in the left and right directions of the X-axis
clamping jaw A grasps the upper workpiece, and clamping jaw B grasps the lower workpiece
C22: Clamp and grasp in the left and right directions of the Y-axis
clamping jaw C grasps the upper workpiece, and clamping jaw D grasps the lower workpiece
C23: Clamp and grasp in two directions: front X-axis and rear Y-axis
clamping jaw A grasps the upper workpiece, and clamping jaw C grasps the lower workpiece
C24: Clamp and grasp in two directions: front X-axis and rear Y-axis
clamping jaw B grasps the upper workpiece, and clamping jaw C grasps the lower workpiece
188 commonly used process methods can be combined based on the effective permutation and combination of the methods to flip the process surface, rotate locating surface, and grasp by the clamping jaw, more process methods can be prepared for the above ways to flip the process surface, rotate locating surface, and grasp by the clamping jaw based on actual needs, and the 188 commonly used process flows can be programmed and entered into the control system.

Working principle: When CNC machining equipment performs single-procedure processing, according to the type of procedure of the material to be processed, the unprocessed material is first manually placed on the material platform 3, the unprocessed material on the material platform 3 is moved to the machining position of the CNC machining equipment by the truss manipulator 6 and the right-angled clamping jaw assembly 4 in the feeding and discharging machine assembly 2 of the CNC machining equipment, and the processed material is moved outside of the CNC machining equipment from the locating clamping assembly 5; when multi-procedure materials are processed, since it is necessary to flip the process surface and rotate the locating surface of the unprocessed material during processing, and according to the actual process requirements, a pair of automatic process surface flipping assemblies 22, the locating rotation assembly 21 and the right-angled clamping jaw assembly 4 on the material transfer platform 1 are used to adaptively complete the flipping of process surface and the rotation of locating surface, solving the problem of manual flipping during the automatic feeding and discharging process of multi-procedure products for CNC machining device, and the problem of merely a few matching products due to the small clamping range of clamping jaw during the feeding and discharging process, so that the method can, without manual object flipping, reduce production costs, improve the production efficiency of CNC machining device, and make significant improvement in terms of production capacity, yield rate and personnel working environment.

The scope of protection of the present invention is not limited to the above embodiments, which are merely the preferred ones, of the present invention. Any equivalent substitution or change made by any person skilled in the art within the technical scope disclosed in the present invention based on the technical solution and its improved concept of the present invention shall be covered within the scope of protection hereof.

1. A process method for automatic feeding and discharging of multi-procedure product on CNC machining device, comprising the following steps:
S1: a technological process in which truss manipulator feeds and discharges materials for the CNC machining device for the first time when processing unprocessed materials of a single process product;
S2: a technological process in which truss manipulator feeds and discharges materials for the CNC machining device for the second time (as well as all subsequent unprocessed materials for this process) when processing unprocessed materials of a single process product;
S3: a technological process in which truss manipulator feeds and discharges materials in the first process for the CNC machining device for the first time when processing unprocessed materials of a multi-procedure product;
S4: a technological process in which truss manipulator feeds and discharges materials in the first process for the CNC machining device for the second time (and all subsequent unprocessed materials for this process) when processing a multi-procedure product;
S5: a technological process in which truss manipulator feeds and discharges materials in the second process for the CNC machining device for the first time (and all subsequent unprocessed materials for this process) when processing a multi-procedure product;
S6: a technological process in which truss manipulator feeds and discharges materials in the second process for the CNC machining device for the second time (and all subsequent unprocessed materials for this process) when processing a multi-procedure product;

2. The process method for automatic feeding and discharging of multi-procedure product on CNC machining device according to claim 1, wherein the CNC machining device in S2 comprises a material transfer platform (1), a feeding and discharging machine assembly (2), a material platform (3), and a locating and clamping assembly (5), the top of the material transfer platform (1) is provided with a locating surface rotating assembly (21), a pair of automatic process surface flipping assemblies (22), and a rotating assembly material tray (23), and the feeding and discharging machine assembly (2) comprises a truss manipulator (6) and a right-angled clamping jaw assembly (4), the right-angled clamping jaw assembly (4) is installed with 1 # clamping jaw (41), 2 # clamping jaw (42), 3 # clamping jaw (43), and 4 # clamping jaw (44), and a material platform tray (31) is installed at the top of the material platform (3).

3. The process method for automatic feeding and discharging of multi-procedure product on CNC machining device according to claim 1, wherein the technological process in S1 in which truss manipulator feeds and discharges materials for the CNC machining device for the first time includes:
Step S11: Manually place unprocessed materials on the material platform;
Step S12: The truss manipulator grasps unprocessed materials from the material platform through 1 # clamping jaw on the clamping jaw mechanism, the clamping jaw mechanism driven by the truss manipulator moves to a suitable position outside the CNC machining device, rotates and moves 2 # clamping jaw to grasping working position, waiting for the CNC machining device to process the material from the previous process, and there is no processed material for the first time;
Step S13: After the material from the previous process is processed, the clamping jaw mechanism driven by the truss manipulator moves to an appropriate position of the locating and clamping mechanism on the CNC machining device, 2 # clamping jaw grasps the processed material on the locating and clamping mechanism, and the clamping jaw mechanism rotates or moves 1 # clamping jaw to the appropriate working position to place unprocessed material a in the locating and clamping mechanism, and under the drive of the truss manipulator, the clamping jaw mechanism clamping processed material moves outside the CNC machining device;
Step S14: The clamping jaw mechanism driven by the truss manipulator clamps and moves the processed material to the material platform, and rotates or moves 2 # clamping jaw to the working position to place the processed material back to the corresponding numbered position on the material platform.

4. The process method for automatic feeding and discharging of multi-procedure product on CNC machining device according to claim 1, wherein the technological process in S2 in which truss manipulator feeds and discharges materials for the CNC machining device for the second time includes:
Step S21: The truss manipulator grasps unprocessed material b from the material platform through 1 # clamping jaw on the clamping jaw mechanism, and sequentially grabs materials with different numbers a., b., c . . . , the clamping jaw mechanism driven by the truss manipulator moves to a suitable position outside the CNC machining device, and rotates and moves 2 # clamping jaw to the working position, waiting for the CNC machining device to process the material from the previous process;
Step S22: After the material from the previous process is processed, the clamping jaw mechanism driven by the truss manipulator moves to the appropriate position of the locating and clamping mechanism on the CNC machining device, 2 # clamping jaw grasps processed material a1 on the locating and clamping mechanism, and sequentially grasps different numbered materials a1. b1. c1 . . . , the clamping jaw mechanism rotates or moves 1 # clamping jaw to the appropriate working position to place the unprocessed material b into the locating and clamping mechanism, and under the drive of the truss manipulator, the clamping jaw mechanism clamping processed material a1 moves outside the CNC machining device;
Step S23: The clamping jaw mechanism driven by the truss manipulator grasps processed material a1 and moves to the material platform, and then rotates or moves 2 # clamping jaw to the working position, and places processed material a1 back to the corresponding numbered position on the material platform;
Step S24: After the truss manipulator performs operation for the CNC machining device for the third time, the technological process of feeding and discharging all materials is the same as that for the second material feeding and discharging, continuously repeat steps S21, S22, and S23 to automatically feed and discharge all materials on the material platform.

5. The process method for automatic feeding and discharging of multi-procedure product on CNC machining device according to claim 1, wherein the technological process in S3 in which truss manipulator feeds and discharges materials in the first process for the CNC machining device for the first time when processing unprocessed materials of a multi-procedure product includes:
Step S31: Manually place unprocessed materials on the material platform;
Step S32: The truss manipulator grasps unprocessed material a from the material platform through 1 # clamping jaw on the clamping jaw mechanism, and sequentially grasps materials with different numbers a., b., c . . . , the clamping jaw mechanism driven by the truss manipulator moves to a suitable position outside the CNC machining device, and rotates or moves 2 # clamping jaw to the working position, waiting for the CNC machining device to process the material from the previous process, and there is no processed material for the first time;
Step S33: After the material from the previous process is processed, the clamping jaw mechanism driven by the truss manipulator moves to the appropriate position of the locating and clamping mechanism on the CNC machining device, 2 # clamping jaw grasps the processed material on the locating and clamping mechanism, and the clamping jaw mechanism rotates or moves 1 # clamping jaw to the appropriate working position, places unprocessed material a in the locating and clamping mechanism, and under the drive of the truss manipulator, the clamping jaw mechanism clamping processed material moves outside the CNC machining device;
Step S34: Driven by the truss manipulator, the clamping jaw mechanism clamping processed material moves to the upper part of material transfer platform, rotates or moves 2 # clamping jaw to the working position, and places processed material on the material tray of locating and rotating mechanism of the material transfer platform and according to the material processing technology and material size, the clamping jaw mechanism rotates or moves 3 # clamping jaw to the working position, and other clamping jaws may be selected according to actual needs;
Step S35: According to the needs of flipping process surface and rotating locating surface of the material, the automatic process surface flipping mechanism grasps processed material from the material tray of locating and rotating mechanism of the transfer platform, and after flipping to the process surface in the second process, places processed material back on the material tray of the locating and rotating mechanism, and the locating and rotating mechanism automatically rotates to meet the needs of flipping process surface and rotating locating surface of materials;
Step S36: Driven by the truss manipulator, 3 # clamping jaw of the clamping jaw mechanism grasps, from the material tray of locating and rotating mechanism, the processed materials for which the process surface has been flipped and the locating surface has been rotated, moves and places processed materials back to the corresponding numbered position on the material platform, and other clamping jaws may be selected according to actual needs.

6. The process method for automatic feeding and discharging of multi-procedure product on CNC machining device according to claim 1, wherein the process flow in S4 in which truss manipulator feeds and discharges materials in the first process for the CNC machining device for the second time includes:
Step S 41: The clamping jaw mechanism rotates or moves 1 # clamping jaw to the working position, the 1 # clamping jaw on the clamping jaw mechanism grasps unprocessed material b, and sequentially grasps materials with different numbers a., b., c., the clamping jaw mechanism driven by the truss manipulator moves to a suitable position outside the CNC machining device, and rotates or moves 2 # clamping jaw to the working position, waiting for the CNC machining device to process the material from the previous process, and other clamping jaws may be selected according to actual needs;
Step S42: After the material from the previous process is processed, the clamping jaw mechanism driven by the truss manipulator moves to an appropriate position of the locating and clamping mechanism on the CNC machining device, 2 # clamping jaw grasps processed material a1 and sequentially grasps different numbered materials a1. b1. c1 . . . , the clamping jaw mechanism rotates or moves 1 # clamping jaw to the working position, and places material b on the locating and clamping mechanism, and under the drive of the truss manipulator, the clamping jaw mechanism clamping processed material a1 moves outside the CNC machining device;
Step S43: Driven by the truss manipulator, the clamping jaw mechanism clamping processed material a1 moves to the material transfer platform, the clamping jaw mechanism rotates or moves 2 # clamping jaw to the working position, places processed material a1 on the material tray of locating and rotating mechanism of the material transfer platform, and according to the material processing technology and material size, the clamping jaw mechanism rotates or moves 3 # clamping jaw to the working position, and other clamping jaws may be selected according to actual needs;
Step S44: According to the needs of flipping process surface and rotating locating surface of the material, the automatic process surface flipping mechanism grasps processed material a1 from the material tray of locating and rotating mechanism of the transfer platform, and after flipping to the process surface in the second process, places processed material a1 back on the material tray of the locating and rotating mechanism, and the locating and rotating mechanism automatically rotates to meet the needs of flipping process surface and rotating locating surface of materials;
Step S 45: Driven by the truss manipulator, 3 # clamping jaw of the clamping jaw mechanism grasps, from the material tray of locating and rotating mechanism, the processed material a1 for which the process surface has been flipped and the locating surface has been rotated, moves and places processed materials back to the corresponding numbered position on the material platform.
Step S46: After the truss manipulator completes the first process of the CNC machining device for the third time, the technological process of feeding and discharging all materials is the same as that for the second material feeding and discharging in the first process, continuously repeat the steps S41, S42, S43, S44, and S45 in cycle to automatically complete the feeding and discharging, the flipping of process surface, and the rotation of locating surface of all materials on the material platform in the first process until the first process is completed for all materials on the material platform.

7. The process method for automatic feeding and discharging of multi-procedure product on CNC machining device according to claim 1, wherein the technological process in S5 in which truss manipulator feeds and discharges materials in the second process for the CNC machining device for the first time includes:
Step S51: The truss manipulator grasps the material a1 for secondary processing from the material platform through 3 # clamping jaw on the clamping jaw mechanism, and sequentially grasps different numbered materials a1, b1, c1 . . . , the clamping jaw mechanism driven by the truss manipulator moves to a suitable position outside the CNC machining device, and rotates or moves 4 # clamping jaw to the working position, waiting for the CNC machining device to process the material from the previous process, and other clamping jaws may be selected according to actual needs;
Step S52: After the material from the previous process is processed, the clamping jaw mechanism driven by the truss manipulator moves to an appropriate position of the locating and clamping mechanism on the CNC machining device, 4 # clamping jaw grasps the secondary-processed material from the locating and clamping mechanism, the clamping jaw mechanism rotates or moves 3 # clamping jaw to the appropriate working position, places the material a1 to be secondary-processed in the locating and clamping mechanism, and under the drive of the truss manipulator, the clamping jaw mechanism clamping the secondary-processed material moves outside the CNC machining device;
Step S53: Driven by the truss manipulator, the clamping jaw mechanism clamping secondary-processed material moves to the material transfer platform, the clamping jaw mechanism rotates or moves 4 # clamping jaw to the working position, places secondary-processed material on the material tray of locating rotating mechanism of the material transfer platform, and according to the material processing technology and material size, the clamping jaw mechanism rotates or moves 2 # clamping jaw to the working position, and other clamping jaws may be selected according to actual needs;
Step S54: According to the needs of flipping process surface and rotating locating surface of the material, the automatic process surface flipping mechanism grasps secondary-processed material from the material tray of locating and rotating mechanism of the transfer platform, and after flipping to the process surface in the third process, places secondary-processed material back on the material tray of locating and rotating mechanism, and the locating and rotating mechanism automatically rotates to meet the needs of flipping process surface and rotating locating surface of secondary-processed materials;
Step S55: Driven by the truss manipulator, 2 # clamping jaw of the clamping jaw mechanism grasps, from the material tray of locating and rotating mechanism, the secondary-processed materials for which the process surface has been flipped and the locating surface has been rotated, moves and places secondary-processed materials back to the corresponding numbered position on the material platform.

8. The process method for automatic feeding and discharging of multi-procedure product on CNC machining device according to claim 1, wherein the technological process in S6 in which truss manipulator feeds and discharges materials in the second process for the CNC machining device for the second time includes:
Step S 61: The clamping jaw mechanism rotates or moves 3 # clamping jaw to the working position, the 1 # clamping jaw on the clamping jaw mechanism grasps the material b1 to be secondary-processed, and sequentially grasps different numbered materials a1, b1, c1 . . . , and under the drive of the truss manipulator, the clamping jaw mechanism moves to a suitable position outside the CNC machining device, rotates or moves 4 # clamping jaw to the working position, waiting for the CNC machining device to process the material from the previous process;
Step S62: After the material from the previous process is processed, the clamping jaw mechanism driven by the truss manipulator moves to an appropriate position of the locating and clamping mechanism on the CNC machining device, 4 # clamping jaw mechanism and locating and clamping mechanism grasps the secondary-processed material a2, and sequentially grasps different numbered materials a 2.b2.c2 . . . , the clamping jaw mechanism rotates or moves 3 # clamping jaw to the working position, places the material b1 to be secondary-processed into the locating and clamping mechanism, and under the drive of the truss manipulator, the clamping jaw mechanism clamping the secondary-processed material a2 moves outside the CNC machining device;
Step S63: Driven by the truss manipulator, the clamping jaw mechanism clamping the secondary-processed material a2 moves to the material transfer platform, rotates or moves 4 # clamping jaw to the working position, and places the secondary-processed material a2 on the material tray of locating rotating mechanism of the material transfer platform and, according to the material processing technology and material size, the clamping jaw mechanism rotates or moves 2 # clamping jaw to the working position, and other clamping jaws may be selected according to actual needs;
Step S64: According to the needs of flipping process surface and rotating locating surface of the material, the automatic process surface flipping mechanism grasps secondary-processed material a2 from the material tray of locating and rotating mechanism of the transfer platform, and after flipping to the process surface in the third process, places secondary-processed material a2 back on the material tray of the locating and rotating mechanism, and the locating and rotating mechanism automatically rotates to meet the needs of flipping process surface and rotating locating surface of materials;
Step S65: Driven by the truss manipulator, 2 # clamping jaw of the clamping jaw mechanism grasps, from the material tray of locating and rotating mechanism, the secondary-processed materials a2 for which the process surface has been flipped and the locating surface has been rotated, moves and places secondary-processed materials a2 back to the corresponding numbered position on the material platform, and other clamping jaws may be selected according to actual needs;
Step S66: After the truss manipulator completes the second process of the CNC machining device for the third time, the technological process of feeding and discharging all materials is the same as that for the second material feeding and discharging in the second process, continuously repeat the steps S61, S62, S63, S64, and S65 in cycle to automatically complete the feeding and discharging, the flipping of process surface, and the rotation of locating surface of all materials on the material platform in the second process until the second process is completed for all materials on the material platform.

9. The process method for automatic feeding and discharging of multi-procedure product on CNC machining device according to claim 1, wherein in step S6, the technological process of truss manipulator feeding and discharging, flipping the process surface, and rotating the locating surface of all materials on the material platform in the third process is the same as that for the second process, continuously repeat the steps S51, S52, S53, S54, S55, S61, S62, S63, S64, S65 and S66 in cycle to automatically complete the feeding and discharging, the flipping of process surface, and the rotation of locating surface of all materials on the material platform in all processes until all the processes are completed for all materials on the material platform.

10. The process method of automatic feeding and discharging of multi-procedure products in CNC machining device according to claim 1, in S1-S6 the technological process of CNC machining device has 6 ways to flip process surface, 4 ways to rotate locating surface, and 12 ways to grasp material, and 188 commonly used process methods can be combined based on the effective permutation and combination of the method to flip the process surface, rotate locating surface, and grasping by the clamping jaw.
